(19) United States
(12) Patent Application Publication
(10) Pub. No.: US 2013/0297196 A1
(43) Pub. Date: Nov. 7, 2013

(54) VEHICULAR DRIVING ASSIST APPARATUS, METHOD, AND VEHICLE

(71) Applicant: Mitsuhisa Shida, Fuji-shi (JP)

(72) Inventor: Mitsuhisa Shida, Fuji-shi (JP)

(73) Assignee: TOYOTA JIDOSHA KABUSHIKI KAISHA, Toyota-shi, Aichi-ken (JP)

(21) Appl. No.: 13/876,972

(22) PCT Filed: Dec. 22, 2010
(86) PCT No.: PCT/IB2010/003333

§ 371 Date: Mar. 29, 2013

(51) Int. Cl. B60W 40/04

(52) U.S. Cl. CPC B60W 40/04
USPC 701/119

(57) ABSTRACT

A driving assist apparatus for a vehicle includes an obtaining portion that obtains a speed of each of a plurality of vehicles, and a target speed calculating portion that calculates a target speed based on a plurality of speeds obtained by the obtaining portion and respective degrees of influence of the plurality of speeds on the target speed. The target speed calculation portion sets the degree of influence of a lower speed to be larger than the degree of influence of a higher speed.

### BACKGROUND OF THE INVENTION

1. Field of the Invention

The invention relates to driving assist apparatus and method for a vehicle, and a vehicle.

2. Description of the Related Art

In recent years, a variety of driving assist apparatuses have been developed to reduced the load on the driver. One such driving assist apparatus is an apparatus that controls the speed of the host vehicle to a target speed, for example. The apparatus described in Japanese Patent Application Publication No. 2007-176355 (JP-A-2007-176355) calculates the speed of a group of vehicles based on the speeds of nearby vehicles that are received by vehicle-to-vehicle communication, and controls the speed of the host vehicle to match the speed of the group of vehicles. Incidentally, the speed of the group of vehicles is the average speed of the nearby vehicles.

However, a vehicle traveling at a low speed within a group of vehicles ahead has a greater affect on the actual flow of traffic than does the closest leading vehicle or the flow of an entire group of vehicles around the host vehicle. For example, even if the host vehicle is traveling with the average speed of the group of vehicles ahead as the target speed, if there is a slow vehicle traveling at a slower speed than the average speed within that group of vehicles, this slow vehicle may slow up vehicles behind it. In this case, the host vehicle must also slow down to a speed equal to or slower than the speed of the slow vehicle. That is, the host vehicle will end up decelerating to a speed equal to or slower than the speed of the slow vehicle after having accelerated to the target speed of the group of vehicles, i.e., needlessly accelerating and decelerating, which makes smooth driving difficult.

### SUMMARY OF THE INVENTION

The invention thus provides a vehicular driving assist apparatus and method that calculate a target speed that suppresses needless acceleration and deceleration, as well as a vehicle in which driving assist is performed based on the target speed.

A first aspect of the invention relates to a driving assist apparatus for a vehicle that includes an obtaining portion that obtains a speed of each of a plurality of vehicles, and a target speed calculating portion that calculates a target speed based on a plurality of speeds obtained by the obtaining portion and respective degrees of influence of the plurality of speeds on the target speed. The target speed calculating portion sets the degree of influence of a lower speed to be larger than the degree of influence of a higher speed.

With the driving assist apparatus according to the first aspect of the invention, the target speed is calculated such that the degree of influence is larger with the speed of a vehicle that affects the traffic flow more (i.e., a slower vehicle). Therefore, needless acceleration and deceleration when the vehicle is driven based on this target speed is able to be suppressed. As a result, driving that is safe and suitable for the traffic flow is possible.

In the driving assist apparatus described above, the obtaining portion may obtain information relating to a traveling tendency of each of the plurality of vehicles in association with the speed, and the target speed calculating portion may change the degree of influence according to the traveling tendency.

According to this driving assist apparatus, the appropriateness being pursued of the vehicles is able to be reflected in the target speed by calculating the target speed according to the traveling tendencies of the vehicles. As a result, safety can be increased and needless acceleration and deceleration can be further suppressed.

A second aspect of the invention relates to a driving assist method for a vehicle. This driving assist method includes obtaining a speed of each of a plurality of vehicles, and calculating a target speed based on a plurality of speeds and respective degrees of influence of the plurality of speeds on the target speed, wherein the degree of influence of a lower speed is set to be larger than a degree of influence of a higher speed.

A third aspect of the invention relates to a vehicle in which driving assist is performed based on a target speed calculated by the driving assist apparatus according to the first aspect.

With the driving assist method according to the second aspect of the invention and the vehicle according to the third aspect of the invention, a target speed is calculated such that the degree of influence is larger with a speed of a vehicle that affects the traffic flow more (i.e., a slower vehicle). As a result, needless acceleration and deceleration when the vehicle is driven based on this target speed is able to be suppressed.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a block diagram of an ACC system according to example embodiments of the invention;

FIG. 2 is an example of a driving scene in which a host vehicle is approaching congestion from behind;

FIG. 3 is an example of a driving scene in which the flow of vehicles around the host vehicle is smooth;

FIG. 4 is a view of weighting given to reference vehicles;

FIG. 5 is a flowchart illustrating a traffic flow cruise control routine of a vehicle control ECU according to a first example embodiment of the invention;

FIG. 6 is a reference chart of weighting based on the positions of the reference vehicles;

FIG. 7 is a flowchart illustrating a traffic flow cruise control routine of a vehicle control ECU according to a second example embodiment of the invention; and

FIG. 8 is a traffic flow cruise control routine of a vehicle control ECU according to a third example embodiment of the invention.

### DETAILED DESCRIPTION OF EMBODIMENTS

Hereinafter, example embodiments of the driving assist apparatus of the invention will be described in greater detail below with reference to the accompanying drawings. Incidentally, like or corresponding elements in the drawings will be denoted by like reference characters, and redundant descriptions of those elements will be omitted.

In this example embodiment, the driving assist apparatus of the invention is applied to an Adaptive Cruise Control (ACC) system provided in a vehicle capable of vehicle-to-vehicle communication and roadside-to-vehicle communication. The vehicle in this example embodiment obtains information about other vehicles around the host vehicle via vehicle-to-vehicle communication, and also obtains information from infrastructure equipment (such as optical beacons) via roadside-to-vehicle communication. The ACC system of this example embodiment detects a leading vehicle ahead of the host vehicle by radar. If a leading vehicle is detected, the ACC system performs control to follow the leading vehicle such that the inter-vehicle time to the leading vehicle (i.e., the distance between vehicles; the inter-vehicle distance) comes to match a target inter-vehicle time. If, on the other hand, a leading vehicle is not detected, the ACC system performs cruise control. (i.e., normal cruise control or traffic flow cruise control) such that the speed of the host vehicle comes to match a target speed. Hereinafter, three example embodiments, each with a different method of weighting when calculating the target speed while traffic flow cruise control is being performed, will be described.

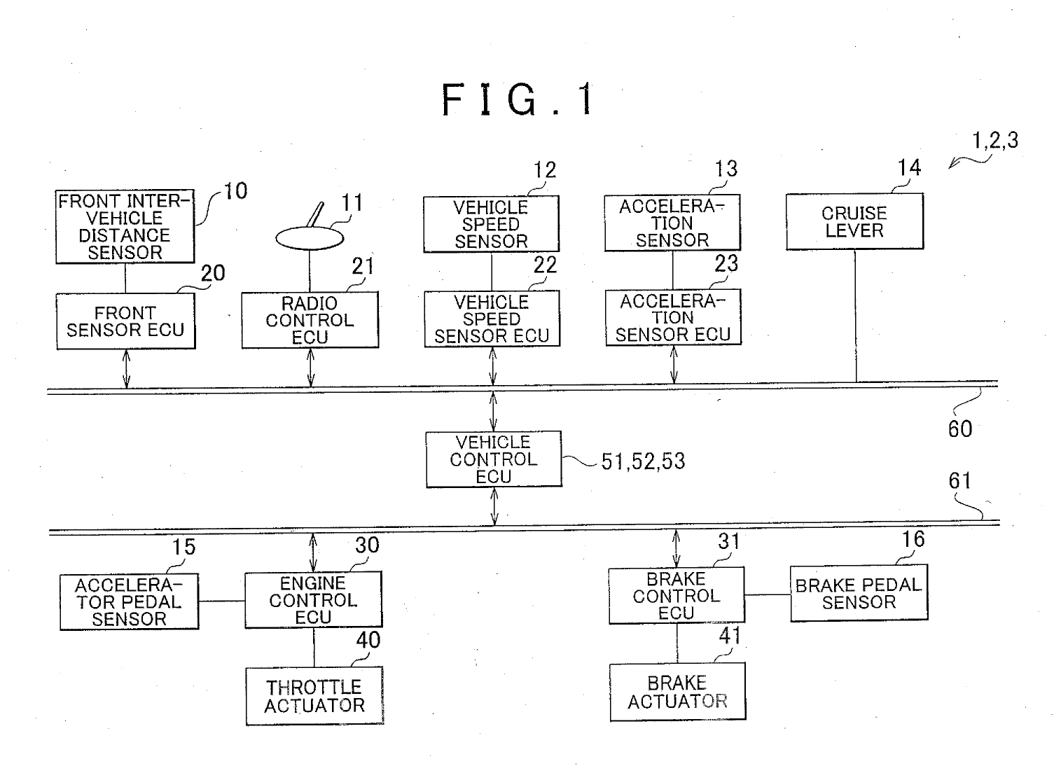

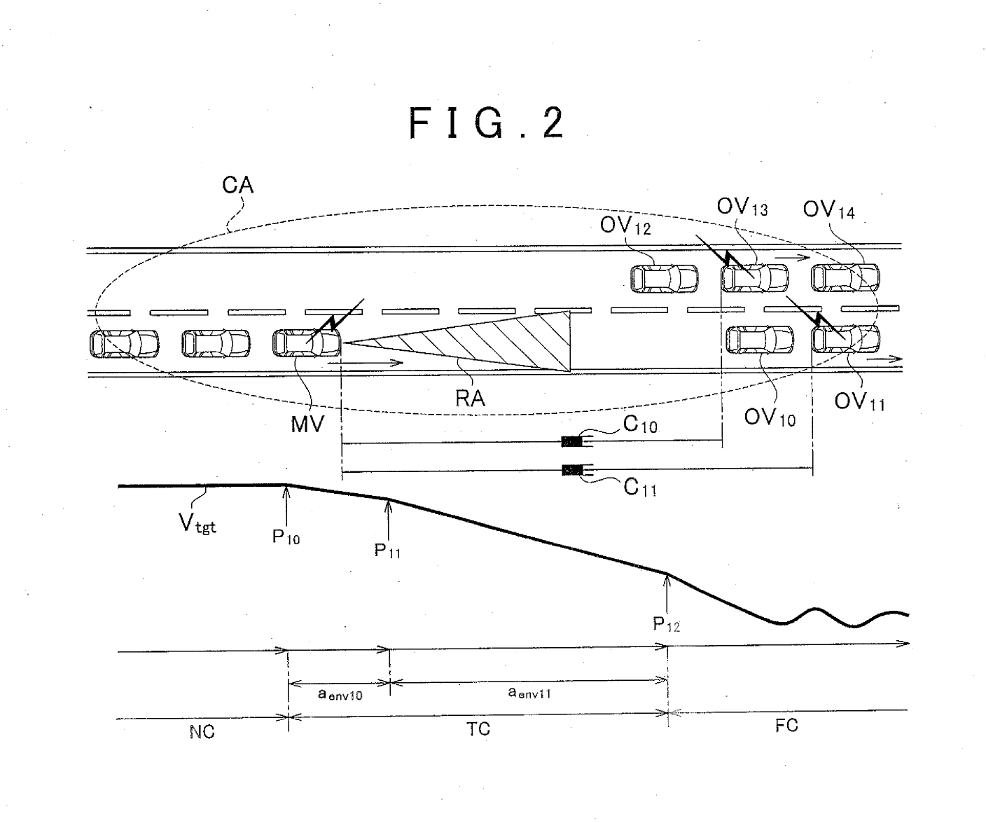

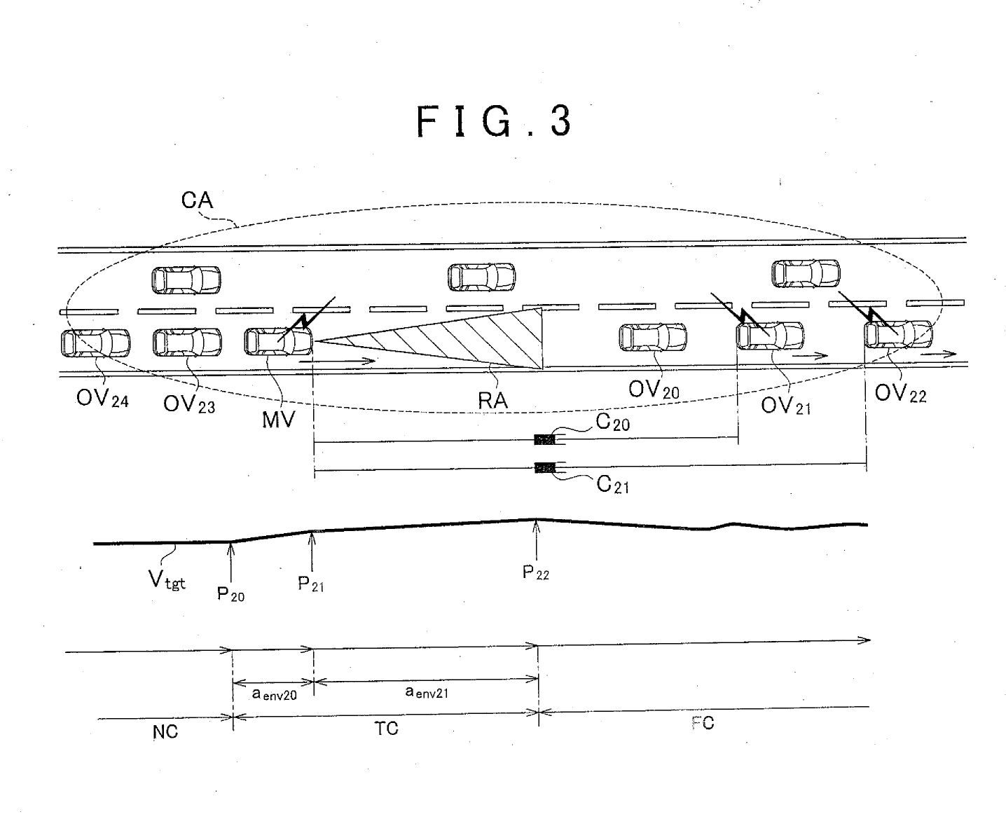

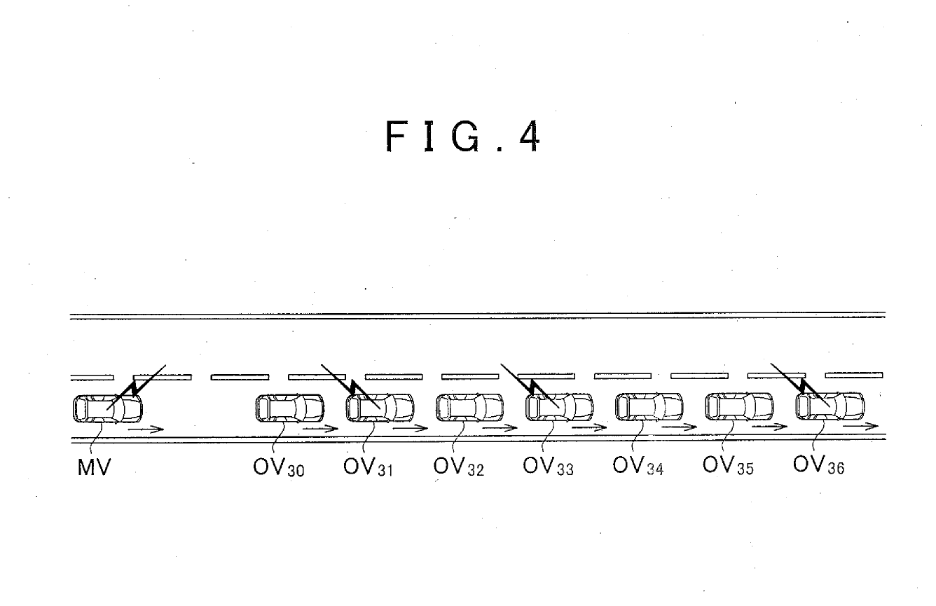

An ACC system 1 according to a first example embodiment will be described with reference to FIGS. 1 to 4. FIG. 1 is a block diagram of the ACC system according to this example embodiment. FIG. 2 is an example of a driving scene in which the host vehicle is approaching congestion from behind. FIG. 3 is an example of a driving scene in which the flow of vehicles around the host vehicle is smooth, and FIG. 4 is a view of weighting given to reference vehicles.

The ACC system 1 normally performs cruise control based on a target speed set by a driver. In particular, when information about other vehicles around the host vehicle is obtained, the ACC system 1 calculates a target speed appropriate for the traffic flow (i.e., the operating speed) around the host vehicle obtained from the information about the other vehicles, and performs cruise control based on the target speed calculated by the ACC system 1.

Before describing the ACC system 1 in detail, the target speed appropriate for the traffic flow around the host vehicle will be described with reference to FIGS. 2 and 3. The example shown in FIG. 2 is one in which there is congestion ahead of the host vehicle, and the example shown in FIG. 3 is one in which the flow of vehicles around the host vehicle is smooth.

In the example shown in FIG. 2, the host vehicle MV is approaching congestion from behind when cruise control is being performed at a high target speed on an expressway or the like. In this case, other vehicles OV₁₀, OV₁₁, . . . ahead in the congestion are traveling at a low speed. On the other hand, the host vehicle MV will normally continue to perform cruise control at the high target speed, and thus travel at a high speed, until the other vehicle OV₁₀ ahead enters the radar detection range RA. Therefore, when host vehicle MV detects the other vehicle OV₁₀ ahead by radar, the relative speed between the host vehicle MV and the other vehicle OV₁₀ ahead is extremely large, so the speed of the host vehicle MV may not be appropriate for the traffic flow ahead. In such a case, the host vehicle MV must reduce the relative speed between the host vehicle MV and the traffic flow ahead in advance.

In the example shown in FIG. 3, when the host vehicle MV is traveling according to cruise control at a relatively low target speed, the nearby vehicles (particularly those ahead) travel smoothly. At this time, other vehicles OV₂₀, OV₂₁, . . . that are traveling ahead in the same lane as the host vehicle are traveling at a somewhat higher speed than the target speed of the host vehicle MV. That is, the host vehicle MV may not be adapting to the surrounding traffic flow (i.e., the operating speed). Also, if the target speed of the host vehicle MV is too low, the host vehicle MV may actually impede the travel of the trailing vehicles OV₂₃ and OV₂₄. In this case, the host vehicle MV needs to quickly adapt to the surrounding traffic flow (i.e., the operating speed).

Therefore, in this example embodiment, information about the speed and the like is obtained from other vehicles around the host vehicle MV by vehicle-to-vehicle communication that has a wider communication range CA than the radar detection range RA. Then a traffic flow-appropriate acceleration that acts to make the speed of the host vehicle MV appropriate for the surrounding traffic flow (particularly ahead) (i.e., match the operating speed) is obtained using the obtained speeds of the other vehicles, and the target speed of the cruise control is changed according to this traffic flow-appropriate acceleration. In this way, when information is obtained from other vehicles by vehicle-to-vehicle communication, the ACC system 1 changes the target speed according to the traffic flow and performs cruise control to realize the target speed appropriate for the traffic flow. In this example embodiment, this kind of control will be referred to as traffic flow cruise control.

With this traffic flow cruise control, the next target speed V_{tgt}_{_{—}}ₙₑₓₜ is calculated according to Expression (1) using the current target speed V_{tgt}_{_{—}}_{now} and the traffic flow-appropriate acceleration aₑₙᵥ. Δt in Expression (1) is the control cycle. When the speed of the host vehicle is V and the speeds of the vehicles of which the traveling states are referenced when obtaining the traffic flow-appropriate acceleration are V₁, V₂, . . . , the traffic flow-appropriate acceleration aₑₙᵥ can be defined according to Expression (2). c₁, c₂, . . . in Expression (2) are the gain.

V_{tgt}_{_{—}}ₙₑₓₜ=V_{tgt}_{_{—}}_{now}+aₑₙᵥΔt (1)

aₑₙᵥ=c₁(V−V₁)°C₂(V−V₂)+ (2)

With the example shown in FIG. 2, in zone NC that is a zone before the host vehicle MV reaches point P₁₀ and in which there are no other vehicles within the communication range CA (particularly ahead of the host vehicle) of vehicle-to-vehicle communication, normal cruise control is performed based on a fixed target speed V_{tgt} set by the driver. In zone TC that is a zone from after the host vehicle MV passes through point P₁₀ until the host vehicle MV reaches point P₁₂ and in which there are other vehicles within the communication range CA of vehicle-to-vehicle communication, traffic flow cruise control is performed based on the target speed V_{tgt} set by the ACC system 1. More specifically, from the time that the host vehicle MV passes through point P₁₀, information transmitted from another vehicle OV₁₃ capable of vehicle-to-vehicle communication starts to be received, and a traffic flow-appropriate acceleration aₑₙᵥ₁₀ is obtained based on the speed of the other vehicle OV₁₃. The target speed V_{tgt} is then updated according to this traffic flow-appropriate acceleration aₑₙᵥ₁₀. Assuming a control model in which the host vehicle MV and the other vehicle OV₁₃ are connected by a damper C₁₀, traffic flow cruise control based on the traffic flow-appropriate acceleration aₑₙᵥ₁₀ is expressed as control that decelerates the host vehicle MV by the damper C₁₀ according to the relative speed between the host vehicle MV and the other vehicle 0V₁₃. Moreover, from the time that the host vehicle MV passes through point P₁₁, information transmitted from another vehicle OV₁₁ capable of vehicle-to-vehicle communication also starts to be received, and a traffic flow-appropriate acceleration aₑₙᵥ₁₁ is obtained based on the speed of the other vehicle OV₁₃ and the speed of the other vehicle OV₁₁. The target speed V_{tgt} is then updated according to this traffic flow-appropriate acceleration aₑₙᵥ₁₁. Assuming a control model in which the host vehicle MV and the other vehicle 0V₁₃ are connected by the damper C₁₀ and a control model in which the host vehicle MV and the other vehicle OV₁₁ are connected by a damper C₁₁, traffic flow cruise control based on the traffic flow-appropriate acceleration aₑₙᵥ₁₁ is expressed as control that decelerates the host vehicle MV by the damper C₁₀ according to the relative speed between the host vehicle MV and the other vehicle OV₁₃ and decelerates the host vehicle MV by the damper C₁₁ according to the relative speed between the host vehicle MV and the other vehicle OV₁₁. Then in zone FC that is a zone after the host vehicle MV passes through point P₁₂ and in which there is another vehicle OV₁₀ within the radar detection range RA, lead vehicle following control is performed based on the target inter-vehicle time. Incidentally, attenuation coefficients of the dampers C₁₀ and C₁₁ correspond to the gain in Expression (2) above.

Also in the example shown in FIG. 3, similar to the example in FIG. 2, normal cruise control is performed in zone NC, traffic flow cruise control is performed in zone TC, and lead vehicle following control is performed in zone FC. More specifically, in zone TC, from the time that the host vehicle MV passes through point P₂₀, information transmitted from another vehicle OV₂₁ capable of vehicle-to-vehicle communication starts to be received, and a traffic flow-appropriate acceleration aₑₙᵥ₂₀ is obtained based on the speed of the other vehicle OV₂₁. Then the target speed V_{tgt} is updated according to this traffic flow-appropriate acceleration aₑₙᵥ₂₀. Assuming a control model in which the host vehicle MV and the other vehicle OV₂₁ are connected by a damper C₂₀, traffic flow cruise control based on the traffic flow-appropriate acceleration aₑₙᵥ₂₀ is expressed as control that accelerates the host vehicle MV by the damper C₂₀ according to the relative speed between the host vehicle MV and the other vehicle OV₂₁. Moreover, from the time that the host vehicle MV passes through point P₂₁, information transmitted from another vehicle OV₂₂ capable of vehicle-to-vehicle communication also starts to be received, and a traffic flow-appropriate acceleration aₑₙᵥ₂₁ is obtained based on the speed of the other vehicle OV₂₁ and the speed of the other vehicle OV₂₂. The target speed V_{tgt} is then updated according to this traffic flow-appropriate acceleration aₑₙᵥ₂₁. Assuming a control model in which the host vehicle MV and the other vehicle OV₂₁ are connected by the damper C₂₀ and a control model in which the host vehicle MV and the other vehicle OV₂₂ are connected by a damper C₂₁, traffic flow cruise control based on the traffic flow-appropriate acceleration aₑₙᵥ₂₁ is expressed as control that accelerates the host vehicle MV by the damper C₂₀ according to the relative speed between the host vehicle MV and the other vehicle OV₂₁ and accelerates the host vehicle MV by the damper C₂₁ according to the relative speed between the host vehicle MV and the other vehicle OV₂₂. Incidentally, attenuation coefficients of the dampers C₂₀ and C₂₁ correspond to the gain in Expression (2) above.

In particular, with the actual flow of traffic, the affect that a vehicle has on the flow of a group of trailing vehicles increases as the vehicle travels at a lower speed. For example, assuming a case in which the operating speed of a group of vehicles ahead is obtained as the average speed of the vehicles for which information is able to be obtained via vehicle-to-vehicle communication, a traffic flow-appropriate acceleration such that the speed of the host vehicle comes to match the operating speed, and traffic flow cruise control is performed, the host vehicle accelerates or decelerates to match the operating speed (i.e., the average speed) of the group of vehicles ahead. However, if there is a slow vehicle that is traveling at a lower speed than the operating speed within the group of vehicles ahead, this slow vehicle will slow up the vehicles behind it, so the host vehicle is also slowed up. As a result, the host vehicle must decelerate. Therefore, when obtaining the traffic flow-appropriate acceleration (and thus the target speed for traffic flow cruise control), more weight must be given to vehicles traveling at lower speeds (i.e., slow vehicles) among the other vehicles capable of obtaining information via vehicle-to-vehicle communication. This is because a slower vehicle among the other vehicles capable of obtaining information via vehicle-to-vehicle communication affects the traffic flow more.

With the example shown in FIG. 4, of the other vehicles OV₃₀, . . . , OV₃₆ ahead of the host vehicle MV, three other vehicles OV₃₁, OV₃₃, and OV₃₆ are vehicles capable of vehicle-to-vehicle communication, so the speeds of these vehicles are able to obtained by the host vehicle MV via vehicle-to-vehicle communication. For example, if the speed of the other vehicle OV₃₁ is 100 km/h, the speed of the other vehicle OV₃₃ is 50 km/h, and the speed of the other vehicle OV₃₆ is 70 km/h, the other vehicle OV₃₁ that is traveling at 100 km/h will presumably catch up to the other vehicle OV₃₃ that is traveling at 50 km/h and slow down. Therefore, the host vehicle MV that is trailing the other vehicle OV₃₁ will be also affected more by the other vehicle OV₃₃ than by the other vehicles OV₃₁ and OV₃₆. Therefore, the traffic flow-appropriate acceleration must be obtained placing the greatest weight on the speed of the other vehicle OV₃₃.

Expression (2) can be changed into Expression (3) using the speed V of the host vehicle and the reference speed V_{ref} (that corresponds to the operating speed) of the group of vehicles made up of reference vehicles of which the traveling states are referenced when obtaining the traffic flow-appropriate acceleration. c in Expression (3) is the gain and is a value that is determined in advance through testing or the like. This reference speed V_{ref} can be calculated according to Expression (4) using the speeds V₁, V₂, . . . , Vₙ of the reference vehicles. m₁, m₂, . . . , mₙ in Expression (4) are weights (i.e., degrees of influence) given to respective reference vehicles, and are set to larger values with more heavily weighted vehicles when obtaining the traffic flow-appropriate acceleration. As shown in Expression (5), the weights m₁, m₂, . . . , mₙ are given values between 0 and 1, such that the sum of the all weights is 1.

aₑₙᵥ=c₁(V−V₁)+C₂(V−V₂)+ . . . =c(V−V_{ref}) (3)

V_{ref}=m₁V₁+m₂V₂+ . . . +mₙVₙ (4)

m₁+m₂+ . . . +mₙ=1 (5)

Now each part of the ACC system 1 will be described in detail. The ACC system 1 includes a front inter-vehicle distance sensor 10, a radio antenna 11, a vehicle speed sensor 12, an acceleration sensor 13; a cruise lever 14, a front sensor electronic control unit. (ECU) 20, a radio control ECU 21, a vehicle speed sensor ECU 22, an acceleration sensor ECU 23, an engine control ECU 30 that is connected to an acceleration pedal sensor 15 and a throttle actuator 40, a brake control ECU 31 that is connected to a brake pedal sensor 16 and a brake actuator 41, and a vehicle control ECU 51. Communication is performed among the front sensor ECU 20, the radio control ECU 21, the vehicle speed sensor ECU 22, the acceleration sensor ECU 23, the cruise lever 14, and the vehicle control ECU 51 by a communication and sensor based controller area network (CAN) 60, and communication is performed among the engine control ECU 30, the brake control ECU 31, and the vehicle control ECU 51 by a control based CAN 61.

Incidentally, in the first example embodiment, the radio antenna 11 and the radio control ECU 21 function as the obtaining portion of the invention, and the vehicle control ECU 51 functions as the target speed calculating portion of the invention.

The front inter-vehicle distance sensor 10 is a radar sensor that detects a vehicle ahead using millimeter waves or the like. The front inter-vehicle distance sensor 10 is mounted in a position at a predetermined height in the center of a front end portion of the host vehicle (i.e., in a position at a height at which it is capable of reliably detecting a vehicle to be detected). The front inter-vehicle distance sensor 10 transmits a radar beam out in front of the host vehicle while scanning left and right, and receives the reflected radar beam. The front inter-vehicle distance sensor 10 outputs radar information (such as the left-right scan angle, the time of transmission, the time of reception, the reception strength, and the like) about each reflected point (i.e., detection point) to the front sensor ECU 20. Incidentally, the front inter-vehicle distance sensor 10 is not limited to being a radar sensor, but may instead be another sensor capable of detecting information related to the area in front of the vehicle. Examples of such other sensors include a laser sensor and a camera.

The front sensor ECU 20 then determines whether there is a vehicle in front of the host vehicle in the lane in which the host vehicle is traveling, within the detection range of the front inter-vehicle distance sensor 10, based on the radar information output from the front inter-vehicle distance sensor 10. If it is determined that there is a vehicle (i.e., a leading vehicle), the front sensor ECU 20 then processes the radar information and outputs the distance from the host vehicle to the leading vehicle (i.e., the inter-vehicle distance) and the like by a digital value. Then the front sensor ECU 20 outputs the information about whether there is a leading vehicle, and if so, the distance and the like, as a front inter-vehicle distance signal to the vehicle control ECU 51.

The radio antenna 11 is a radio antenna that both transmits and receives signals. Also, the radio antenna 11 is a common antenna used both for vehicle-to-vehicle communication and roadside-to-vehicle communication. When communicating among vehicles (i.e., vehicle-to-vehicle communication), the radio antenna 11 receives signals from vehicles capable of vehicle-to-vehicle communication that are within the communication range and transmits signals to vehicles within the communication range. When transmitting a signal, a vehicle-to-vehicle transmitting signal is output from the radio control ECU 21 to the radio antenna 11. When a signal has been received, a vehicle-to-vehicle receiving signal is output from the radio antenna 11 to the radio control ECU 21. When communicating with infrastructure on roadside (i.e., roadside-to-vehicle communication), the radio antenna 11 receives signals from infrastructure equipment (such as an optical beacon) and transmits signals to the infrastructure equipment. When transmitting a signal, a roadside-to-vehicle transmitting signal is output from the radio control ECU 21 to the radio antenna 11. When a signal has been received, a roadside-to-vehicle transmitting signal is output from the radio antenna 11 to the radio control ECU 21.

The radio control ECU 21 controls various signals that are transmitted and received wirelessly. With vehicle-to-vehicle communication, the radio control ECU 21 applies various conversion processes to vehicle-to-vehicle transmission information from the vehicle control ECU 51 and generates a vehicle-to-vehicle transmitting signal that it then outputs to the radio antenna 11. Also, the radio control ECU 21 applies various conversion processes to a vehicle-to-vehicle receiving signal received by the radio antenna 11 and extracts the information that it then outputs to the vehicle control ECU 51 as a vehicle-to-vehicle received information signal. Examples of information transmitted and received via vehicle-to-vehicle communication include vehicle speed, position, acceleration, traveling lane, road type (such as an expressway, an ordinary road and the like), and vehicle identification information (information for specifying or identifying the source vehicle, such as the vehicle ID). With roadside-to-vehicle communication, the radio control ECU 21 applies various conversion processes to roadside-to-vehicle transmission information from the vehicle control ECU 51 and generates a roadside-to-vehicle transmitting signal that it outputs to the radio antenna 11. Also, the radio control ECU 21 applies various conversion processes to the roadside-to-vehicle receiving signal received by the radio antenna 11 and extracts the information that it then outputs to the vehicle control ECU 51 as a roadside-to-vehicle received information signal. An example of information transmitted via roadside-to-vehicle communication is vehicle identification information, and examples of information received via roadside-to-vehicle communication include traffic information (such as congestion information, traffic (and road) restriction information, and travel speeds and the like) and road infrastructure information. Traffic information may include information provided via the Vehicle Information Communication System (VICS) (registered trademark in Japan) used in Japan, or a similar system or technology. Also, road infrastructure information may include information relating to the time or timing when traffic lights will change. Information about the traveling lanes of the vehicles may also be able to be received via roadside-to-vehicle communication.

Incidentally, the radio antenna and the radio control ECU are not limited to being shared by vehicle-to-vehicle communication and roadside-to-vehicle communication. That is, a separate radio antenna and radio control ECU may be used for vehicle-to-vehicle communication than are used for roadside-to-vehicle communication. Also, roadside-to-vehicle communication may also be such that information is only received instead of being both transmitted and received.

The vehicle speed sensor 12 is a sensor for detecting the speed of the host vehicle. The vehicle speed sensor 12 detects information related to the speed of the host vehicle and outputs the detected information to the vehicle speed sensor ECU 22 at regular intervals of time.

The vehicle speed sensor ECU 22 then processes the information output from the vehicle speed sensor 12 and outputs the speed of the host vehicle that is a digital value. The vehicle speed sensor ECU 22 outputs this speed of the host vehicle to the vehicle control ECU 51 as a vehicle speed signal.

The acceleration sensor 13 is a sensor for detecting acceleration of the host vehicle. The acceleration sensor 13 detects information related to acceleration of the host vehicle and outputs this detected information to the acceleration sensor ECU 23 at regular intervals of time.

The acceleration sensor ECU 23 processes the information output from the acceleration sensor 13 and outputs the acceleration of the host vehicle that is a digital value. The acceleration sensor ECU 23 outputs this acceleration of the host vehicle to the vehicle control ECU 51 as an acceleration signal.

The cruise lever 14 is a lever for performing various operations such as turning the ACC system 1 on (to start) and off (to stop), and setting the target speed (i.e., an up operation to increase the speed by a predetermined speed and a down operation to decrease the speed by a predetermined speed are possible). The cruise lever 14 outputs information related to an operation performed by the driver to the vehicle control ECU 51 as a cruise lever signal. Incidentally, a lever or a switch may also be provided separately from the cruise lever 14, or incorporated into the cruise lever 14, in order to set the target inter-vehicle time (i.e., the target vehicle-to-vehicle distance) (to long, medium or short, for example) when lead vehicle following control is performed.

The acceleration pedal sensor 15 is a sensor that detects the depression amount (i.e., the accelerator operation amount) of an accelerator pedal, not shown. The acceleration pedal sensor 15 detects the depression amount of the accelerator pedal and outputs the detected depression amount to the engine control ECU 30 as an accelerator pedal signal at regular intervals of time.

The engine control ECU 30 is a control unit that controls the engine. The engine control ECU 30 normally sets a target acceleration according to the depression amount of the accelerator pedal by the driver, based on the accelerator pedal signal from the acceleration pedal sensor 15 at regular intervals of time. Then the engine control ECU 30 sets a target opening amount of a throttle valve necessary to realize the target acceleration, and outputs the target opening amount to the throttle actuator 40 as a target throttle opening amount signal.

The throttle actuator 40 is an actuator that adjusts the opening amount of the throttle valve. Upon receiving the target throttle opening amount signal from the engine control ECU 30, the throttle actuator 40 operates according to the target opening amount and adjusts the opening amount of the throttle valve.

The brake pedal sensor 16 is a sensor that detects the depression amount of a brake pedal, not shown. The brake pedal sensor 16 detects the depression amount of the brake pedal and outputs the detected depression amount to the brake control ECU 31 as a brake pedal signal at regular intervals of time.

The brake control ECU 31 is a control unit that controls the braking of the wheels. The brake control ECU 31 normally sets a target deceleration according to the depression amount of the brake pedal by the driver, based on the brake pedal signal from the brake pedal sensor 16 at regular intervals of time. Then the brake control ECU 31 sets a target brake pressure of wheel cylinders, not shown, of the wheels necessary to realize the target deceleration, and outputs the target brake pressure to the brake actuator 41 as a target pressure signal.

The brake actuator 41 is an actuator that regulates the brake pressure of the wheel cylinders of the wheels. Upon receiving the target pressure signal from the brake control ECU 31, the brake actuator 41 operates according to the target brake pressure and regulates the brake pressure in the wheel cylinders.

The vehicle control ECU 51 is an electronic control unit formed of a central processing unit (CPU), read only memory (ROM), and random access memory (RAM), and the like, and is responsible for controlling the ACC system 1. When activated according to ON operation information indicated by a cruise lever signal from the cruise lever 14, the vehicle control ECU 51 performs lead vehicle following control, normal cruise control, traffic flow cruise control, selection of control to perform and the like by loading an application program stored in the ROM into RAM and executing the program with the CPU. At regular control cycles At, the vehicle control ECU 51 determines which control to perform, from among the lead vehicle following control, the normal cruise control, and the traffic flow cruise control, (i.e., the selection of control to perform) and performs the selected control. Also, each time an up operation amount or a down operation amount indicated by the cruise lever signal from the cruise lever 14 is obtained, the vehicle control ECU 51 multiplies this operation amount by a gain and calculates a new target speed that is equal to the currently set target speed plus the speed of the up amount or the down amount. This target speed set by the driver is displayed so as to be visible to the driver.

The selection of control will now be described. The vehicle control ECU 51 determines whether there is a leading vehicle ahead of the host vehicle based on the front inter-vehicle distance signal from the front sensor ECU 20. If it is determined that there is a leading vehicle, the vehicle control ECU 51 performs lead vehicle following control. If, on the other hand, it is determined that there is no leading vehicle, the vehicle control ECU 51 determines whether there are any other vehicles capable of vehicle-to-vehicle communication around (particularly in front of) the host vehicle based on a vehicle-to-vehicle received information signal from the radio control ECU 21. If it is determined that there is not another vehicle capable of vehicle-to-vehicle communication around the host vehicle, the vehicle control ECU 51 performs normal cruise control. If, on the other hand, it is determined that there is another vehicle capable of vehicle-to-vehicle communication around the host vehicle, the vehicle control ECU 51 performs traffic flow cruise control.

Next, lead vehicle following control will be described. The vehicle control ECU 51 calculates the inter-vehicle time (=inter-vehicle distance/host vehicle speed) to the leading vehicle using the inter-vehicle distance to the leading vehicle indicated by the front inter-vehicle distance signal from the front sensor ECU 20 and the speed of the host vehicle indicated by the vehicle speed signal from the vehicle speed sensor ECU 22. Then the vehicle control ECU 51 calculates a target speed change amount necessary to make the inter-vehicle time to the leading vehicle match the target inter-vehicle time, based on the difference between the inter-vehicle time and the target inter-vehicle time. If the target speed change amount is a positive value (i.e., if acceleration control is necessary), the vehicle control ECU 51 sets a target acceleration and outputs this target acceleration to the engine control ECU 30 as an engine control signal. If the target speed change amount is a negative value (i.e., if deceleration control is necessary), the vehicle control ECU 51 sets a target deceleration and outputs this target deceleration to the brake control ECU 31 as a brake control signal. Incidentally, the target inter-vehicle time used in lead vehicle following control is a target inter-vehicle time that is set by the driver using the lever or the like (the default value is a “long” target inter-vehicle time, for example).

Next, normal cruise control will be described. The vehicle control ECU 51 calculates a target speed change amount necessary to make the speed of the host vehicle match the target speed, based on the difference between the speed of the host vehicle indicated by the vehicle speed signal from the vehicle speed sensor ECU 22 and the target speed. If the target speed change amount is a positive value, the vehicle control ECU 51 sets a target acceleration and outputs this target acceleration to the engine control ECU 30 as an engine control signal. If the target speed change amount is a negative value, the vehicle control ECU 51 sets a target deceleration and outputs this target deceleration to the brake control ECU 31 as a brake control signal. Incidentally, the target inter-vehicle time used in normal cruise control is a target speed that is set by the driver using the cruise lever 14.

Next, traffic flow cruise control will be described. The vehicle control ECU 51 obtains vehicle-to-vehicle received information included in the vehicle-to-vehicle received information signal from the radio control ECU 21. The vehicle-to-vehicle received information is information about, for example, the road type, the traveling lane, the position, the acceleration, the speed, and the vehicle ID of each other vehicle capable of vehicle-to-vehicle communication around the host vehicle. Also, when a signal from infrastructure equipment is able to be received, the vehicle control ECU 51 obtains roadside-to-vehicle received information included in the roadside-to-vehicle received information signal from the radio control ECU 21. The roadside-to-vehicle received information is information about, for example, the traveling lane of each vehicle ID and the like. Also, the vehicle control ECU 51 selects reference vehicles of which the traveling states are referenced when obtaining a traffic flow-appropriate acceleration (and thus the target speed for traffic flow cruise control) from among other vehicles capable of vehicle-to-vehicle communication, based on the vehicle-to-vehicle received information and the roadside-to-vehicle received information (only when able to be obtained). The vehicle control ECU 51 basically selects another vehicle that is traveling ahead of and in the same direction as the host vehicle, and in the same lane as the host vehicle, as a reference vehicle. However, depending on the circumstances, the vehicle control ECU 51 may also select another vehicle that is traveling in the same direction as the host vehicle and ahead of the host vehicle but in a different lane than the host vehicle, or another vehicle that is traveling in the same direction as the host vehicle but behind the host vehicle, as a reference vehicle. If information of the traveling lane of another vehicle is unable to be obtained, another vehicle that is traveling on the same type of road is selected as a reference vehicle.

The vehicle control ECU 51 sits a weight mᵢ for each reference vehicle, with the weight being larger for reference vehicles traveling at lower speeds, based on the speeds of all of the selected reference vehicles. As the method of weighting, a larger weight is set for a slower reference vehicle, such that the total value of all of the weights is 1 (see Expression (5)), using a map that correlates a larger weight with a slower vehicle speed, for example. This map may be adjusted according to the number of reference vehicles and the driving scene (such as a scene in which the vehicle is approaching congestion ahead, a scene in which the vehicle is driving through congestion, a scene in which the vehicle is traveling smoothly at a low speed, or a scene in which the vehicle is traveling smoothly at a high speed or the like). Incidentally, when only one reference vehicle is selected, the weight of this reference vehicle is 1.

The vehicle control ECU 51 calculates a reference speed V_{ref} according to Expression (4) above using the vehicle speed Vᵢ and weight mᵢ of each reference vehicle. Further, the vehicle control ECU 51 calculates a traffic flow-appropriate acceleration aₑₙᵥ according to Expression (3) above using the reference speed V_{ref} and the speed V of the host vehicle. Then the vehicle control ECU 51 calculates the next target speed V_{tgt}_{_{—}}ₙₑₓₜ according to Expression (1) above using the traffic flow-appropriate acceleration aₑₙᵥ and the current target speed V_{tgt}_{_{—}}_{now}. Then the vehicle control ECU 51 performs acceleration/deceleration control similar to normal cruise control using this calculated next target speed V_{tgt}_{_{—}}ₙₑₓₜ as the target speed.

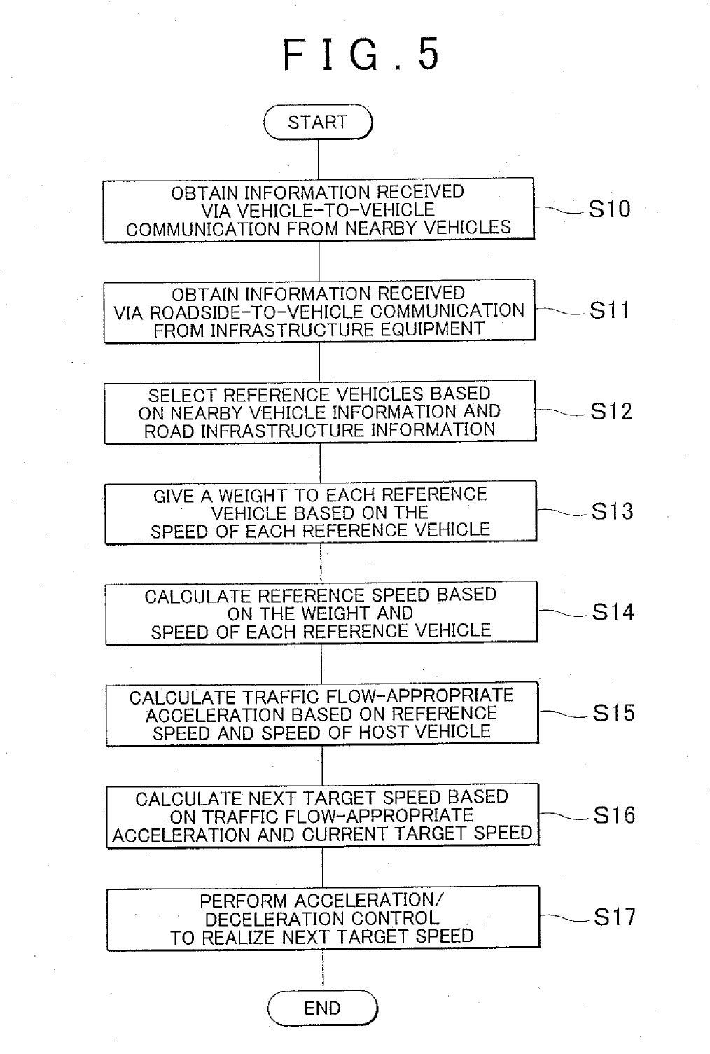

Now the operation during traffic flow cruise control of the ACC system 1 will be described with reference to FIG. 1. In particular, a traffic flow cruise control routine of the vehicle control ECU 51 will be described with reference to the flowchart in FIG. 5. FIG. 5 is a flowchart illustrating the traffic flow cruise control routine of the vehicle control ECU 51 according to the first example embodiment. Here, a case will be described in which the ACC system 1 is activated in response to an ON operation of the cruise lever 14 by the driver and information is obtained from other vehicles capable of vehicle-to-vehicle communication around the host vehicle via vehicle-to-vehicle communication, but a leading vehicle is unable to be detected by the front inter-vehicle distance sensor 10.

The front inter-vehicle distance sensor 10 transmits a radar beam while scanning the area in front of the host vehicle at regular intervals of time, and receives the reflected radar beam when the radar beam is reflected. The front inter-vehicle distance sensor 10 then outputs the radar information to the front sensor ECU 20. The front sensor ECU 20 receives this radar information, determines whether there is a leading vehicle based on the radar information, and outputs a front inter-vehicle distance signal indicative of the determination to the vehicle control ECU 51.

Every time a signal is transmitted from another vehicle within the communication range, the radio antenna 11 receives the transmitted signal, and outputs a vehicle-to-vehicle receiving signal to the radio control ECU 21. Upon receiving this vehicle-to-vehicle receiving signal, the radio control ECU 21 extracts various information about the other vehicle from the vehicle-to-vehicle receiving signal, and outputs a vehicle-to-vehicle received information signal to the vehicle control ECU 51. The vehicle control ECU 51 receives this vehicle-to-vehicle received information signal and obtains the information about the other vehicle around the host vehicle (S10).

Also, when the host vehicle is passing through a transmitting area of infrastructure equipment, the radio antenna 11 receives a signal transmitted from the infrastructure equipment and outputs a roadside-to-vehicle receiving signal to the radio control ECU 21. Upon receiving this roadside-to-vehicle receiving signal, the radio control ECU 21 extracts road infrastructure information from the roadside-to-vehicle receiving signal and outputs a roadside-to-vehicle received information signal to the vehicle control ECU 51. The vehicle control ECU 51 then receives this roadside-to-vehicle received information signal and obtains the road infrastructure information (S11).

The vehicle speed sensor 12 detects information relating to the speed of the host vehicle and outputs this information to the vehicle speed sensor ECU 22 at regular intervals of time. Upon receiving this information from the vehicle speed sensor 12, the vehicle speed sensor ECU 22 performs various processing and outputs the speed of the host vehicle that is a digital value to the vehicle control ECU 51 as a vehicle speed signal. The vehicle control ECU 51 receives this vehicle speed signal and obtains the speed of the host vehicle.

The acceleration sensor 13 detects information relating to acceleration of the host vehicle and outputs this information to the acceleration sensor ECU 23 at regular intervals of time. Upon receiving this information from the acceleration sensor 13, the acceleration sensor ECU 23 performs various processing and outputs the acceleration of the host vehicle that is a digital value to the vehicle control ECU 51 as an acceleration signal. The vehicle control ECU 51 receives this acceleration signal and obtains the acceleration of the host vehicle.

The acceleration pedal sensor 15 detects the depression amount of the accelerator pedal and outputs an accelerator pedal signal to the engine control ECU 30 at regular intervals of time. The engine control ECU 30 receives this accelerator pedal signal and obtains the depression amount of the accelerator pedal.

The brake pedal sensor 16 detects the depression amount of the brake pedal and outputs a brake pedal signal to the brake control ECU 31 at regular intervals of time. The brake control ECU 31 receives this brake pedal signal and obtains the depression amount of the brake pedal.

At each control cycle Δt, the vehicle control ECU 51 selects reference vehicles of which the traveling states are referenced when obtaining a traffic flow-appropriate acceleration, from among the other vehicles capable of vehicle-to-vehicle communication around the host vehicle, based on information of other vehicles capable of vehicle-to-vehicle communication around the host vehicle and road infrastructure information (only when able to be obtained) (S12). Then the vehicle control ECU 51 gives a weight to each reference vehicle based on the speed Vᵢ of each selected reference vehicle (S13).

The vehicle control ECU 51 calculates a reference speed V_{ref} according to Expression (4) based on the weight mᵢ and speed Vᵢ of each reference vehicle (S14). Then the vehicle control ECU 51 calculates a traffic flow-appropriate acceleration aₑₙᵥ according to Expression (2) based on the reference speed V_{ref} and the speed V of the host vehicle (S15). Further, the vehicle control ECU 51 calculates a next target speed V_{tgt}_{_{—}}ₙₑₓₜ according to Expression (1) based on the traffic flow-appropriate acceleration aₑₙᵥ and the Current target speed V_{tgt}_{_{—}}_{now} (S16).

The vehicle control ECU 51 then calculates a target speed change amount necessary to make the speed of the host vehicle match the target speed, based on the difference between the speed V of the host vehicle and the next target speed V_{tgt}_{_{—}}ₙₑₓₜ (S17). If the target speed change amount is a positive value, the vehicle control ECU 51 sets a target acceleration and outputs an engine control signal to the engine control ECU 30 (S17). Upon receiving this engine control signal, the engine control ECU 30 sets a target opening amount of the throttle valve necessary to realize the target acceleration indicated by the engine control signal, and outputs a target throttle opening amount signal to the throttle actuator 40. Upon receiving this target throttle opening amount signal, the throttle actuator 40 operates according to the target opening amount indicated by the target throttle opening amount signal and adjusts the opening amount of the throttle valve. As a result, the host vehicle accelerates to the next target speed. V_{tgt}_{_{—}}ₙₑₓₜ (and thus the traffic flow-appropriate acceleration aₑₙᵥ is realized). If the target acceleration or deceleration is a negative value, the vehicle control ECU 51 sets a target deceleration and outputs a brake control signal to the brake control ECU 31 (S17). Upon receiving this brake control signal, the brake control ECU 31 sets a target brake pressure of the wheel cylinder for each wheel necessary to realize the target deceleration indicated by the brake control signal, and outputs a target pressure signal to the brake actuator 41. Upon receiving this target pressure signal, the brake actuator 41 operates according to the target brake pressure indicated by the target pressure signal, and adjusts the brake pressure of the wheel cylinders. As a result, the host vehicle decelerates to the next target speed V_{tgt}_{_{—}}ₙₑₓₜ (and thus the traffic flow-appropriate acceleration aₑₙᵥ is realized).

According to this ACC system 1, setting a larger weight for a slower reference vehicle that will affect the traffic flow more and calculating the traffic flow-appropriate acceleration (and thus the target speed) makes it possible to suppress needless acceleration and deceleration while cruising based on the calculated target speed even if there is another vehicle for which the host vehicle is unable to obtain information (i.e., another vehicle incapable of vehicle-to-vehicle communication). As a result, smooth driving that is safe and appropriate for the traffic flow is possible. For example, when approaching congestion ahead, it is possible to start decelerating before a vehicle ahead is detected by radar, and when the flow of nearby vehicles is smooth, the vehicle is quickly able to adapt to the flow.

By obtaining information about other vehicles around the host vehicle using vehicle-to-vehicle communication, the ACC system 1 is able to achieve a more reliable traffic flow-appropriate acceleration, and thus more appropriate cruise control can be performed, as the number of other vehicles capable of vehicle-to-vehicle communication that are within the communication range of vehicle-to-vehicle communication, heading in the same direction as, and in front of, the host vehicle increases. At this time, it is acceptable for the accuracy of the positions of the other vehicles to be low as long as the speeds and traveling lanes of the other vehicles are able to be accurately obtained. Also, the other vehicles with which communication is taking place may not need to be identified. Therefore, the ACC system 1 is able to be easily realized.

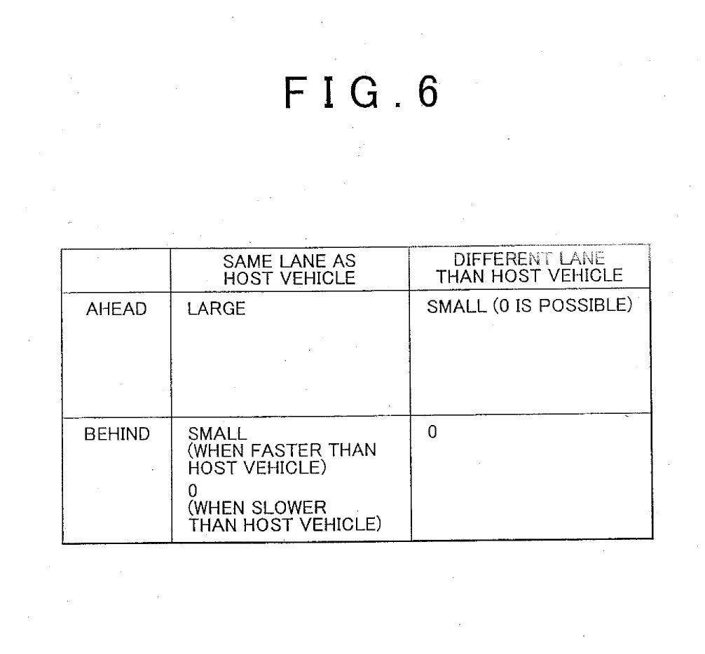

Next, an ACC system 2 according to a second example embodiment of the invention will be described with reference to FIGS. 1 and 6. FIG. 6 is a reference chart of weighting based on the positions of the reference vehicles.

The ACC system 2 differs from the ACC system 1 according to the first example embodiment in that it calculates the target speed taking the positions as well as the speeds of the reference vehicles around the host vehicle into account during traffic flow cruise control. Therefore, the only structure of the ACC system 2 that differs from the structure of the ACC system 1 according to the first example embodiment is a vehicle control ECU 52. Incidentally, in the second example embodiment, the vehicle control ECU 52 functions as the target traveling speed calculating portion of the invention.

The vehicle control ECU 52 only differs from the vehicle control ECU 51 of the first example embodiment in terms of the traffic flow cruise control routine. Therefore, only the traffic flow cruise control of the vehicle control ECU 52 will be described.

The vehicle control ECU 52 selects a reference vehicle for obtaining a traffic flow-appropriate acceleration from among other vehicles capable of vehicle-to-vehicle communication, by a process similar to the vehicle control ECU 51 in the first example embodiment. Here, the vehicle control ECU 52 selects, as reference vehicles, another vehicle that is traveling in a non-host vehicle lane (i.e., a lane other than the lane in which the host vehicle is traveling in) ahead of the host vehicle, and another vehicle that is traveling in a host vehicle lane (i.e., the lane that the host vehicle is traveling in) behind the host vehicle, in addition to another vehicle that is traveling in the host vehicle lane ahead of the host vehicle. Incidentally, the reference vehicles are selected from among other vehicles traveling in the same direction as the host vehicle.

Then the vehicle control ECU 52 sets the weight mᵢ of each reference vehicle based on the speed and position (including the traveling lane information) of each selected reference vehicle. Regarding the speed, a larger weight is set for a slower reference vehicle according to a method similar to the method described in the first example embodiment. Also, regarding the position, the weight of a reference vehicle that is traveling in the host vehicle lane ahead of the host vehicle is set large, and the weight of a reference vehicle traveling in the non-host vehicle lane ahead of the host vehicle is set small (and may even be 0), as shown in FIG. 6. Also, regarding a reference vehicle traveling in the host vehicle lane behind the host vehicle, the weight of a reference vehicle traveling faster than the host vehicle is set small, and the weight of a reference vehicle traveling slower than the host vehicle is set to 0. For example, first the weight is set for each reference vehicle according to the speed. Next, the weight set according to the speed is multiplied by a first coefficient that is larger than 1 for a reference vehicle traveling in the host vehicle lane ahead of the host vehicle, the weight set according to the speed is multiplied by a second coefficient (which may be 0) that is smaller than 1 for a reference vehicle that is traveling in a non-host vehicle lane ahead of the host vehicle, and the weight set according to the speed is multiplied by a third coefficient (which may be 0) that is smaller than 1 for a reference vehicle that is traveling in the host vehicle lane behind the host vehicle and faster than the host vehicle. Each of these coefficients may be appropriately adjusted such that the total value of all of the weights is 1.

The speed of the host vehicle is basically affected by the speeds of the other vehicles traveling ahead in the host vehicle lane. However, when there is congestion or the like, the speed of another vehicle traveling ahead in a non-host vehicle lane may also be taken into account. Therefore, when taking the speed of another vehicle traveling ahead in a non-host vehicle lane into account, a weight that is smaller than the weight of the reference vehicle traveling ahead in the host vehicle lane, but that is not 0, is set for the reference vehicle traveling ahead in the non-host vehicle lane, such that the speed of the other vehicle traveling ahead in the non-host vehicle lane contributes to the calculation of the traffic flow-appropriate acceleration. However, if the speed of another vehicle traveling ahead in a non-host vehicle lane is not taken into account, the weight of a reference vehicle traveling ahead in a non-host vehicle lane is set to 0 and thus does not contribute to the calculation of the traffic flow-appropriate acceleration.

Also, the speed of the host vehicle is not affected by another vehicle traveling behind in a non-host vehicle lane. However, if the speed of another vehicle in the host vehicle lane behind the host vehicle is faster than the speed of the host vehicle, this other vehicle following the host vehicle will be slow up and held up. Therefore, the speed of the other vehicle traveling behind in the host vehicle lane may also be taken into account to inhibit congestion in the vicinity around the host vehicle. Thus, only when the speed of another vehicle traveling behind in the host vehicle lane is faster than the speed of the host vehicle, a weight that is smaller than the weight of a reference vehicle traveling ahead in the host vehicle lane, but that is not 0, is set for a reference vehicle traveling behind in the host vehicle lane, such that the speed of the other vehicle traveling behind in the host vehicle lane also contributes to the calculation of the traffic flow-appropriate acceleration.

When the weights mᵢ of all of the reference vehicles are set, the vehicle control ECU 52 sequentially calculates the reference speed V_{ref}, the traffic flow-appropriate acceleration aₑₙᵥ, and the next target speed V_{tgt}_{_{—}}ₙₑₓₜ according to a process similar to the process performed by the vehicle control ECU 51 in the first example embodiment, and performs acceleration/deceleration control based on this next target speed V_{tgt}_{_{—}}ₙₑₓₜ.

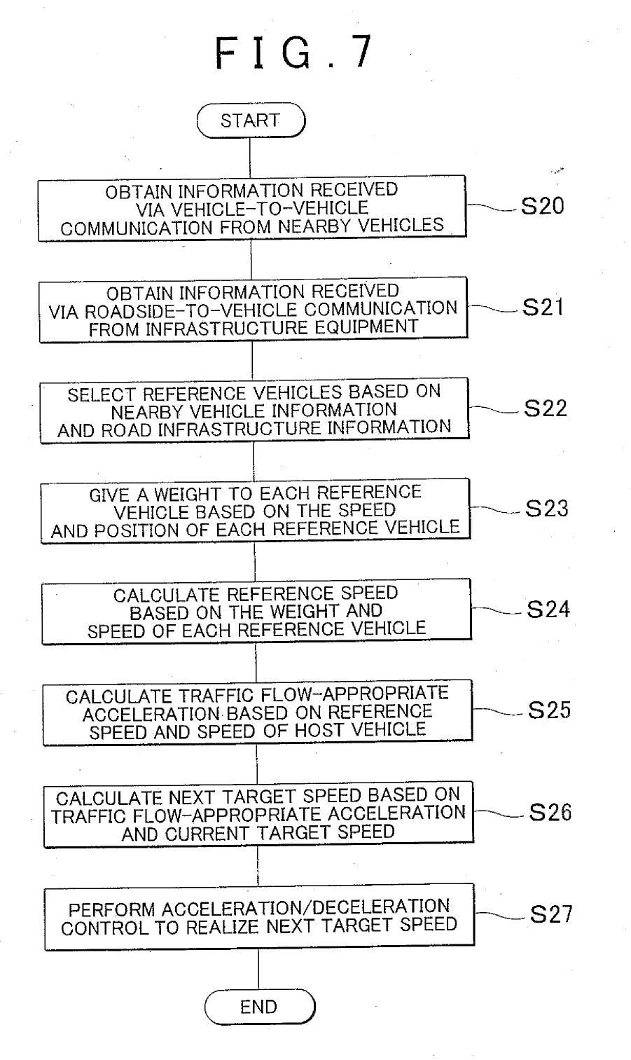

Now the operation during traffic flow cruise control of the ACC system 2 will be described with reference to FIGS. 1 and 6. In particular, a traffic flow cruise control routine of the vehicle control ECU 52 will be described with reference to the flowchart shown in FIG. 7. FIG. 7 is a flowchart illustrating a traffic flow cruise control routine of the vehicle control ECU 52 according to the second example embodiment of the invention. Here, the operation of the ACC system 2 differs from the operation of the ACC system 1 described in the first example embodiment only in terms of the routine of the vehicle control ECU 52, so only the routine of the vehicle control ECU 52 will be described.

Steps S20 to S22 performed by the vehicle control ECU 52 are the same as steps S10 to S12 performed by the vehicle control ECU 51 in the first example embodiment. When selecting the reference vehicles in step S22, the vehicle control ECU 52 gives a weight to each reference vehicle based on the speed and position of each selected reference vehicle (S23). Then the vehicle control ECU 52 performs steps S24 to S27 that are the same as steps S14 to S17 performed by the vehicle control ECU 51 in the first example embodiment.

In addition to having the effects of the ACC system 1 in the first example embodiment, this ACC system 2 also has the effects described below. With the ACC system 2, it is possible to set a more appropriate weight according to the degree of influence that the reference vehicles have on the host vehicle by taking into account the positions as well as the speeds when setting the weights of the reference vehicles. Accordingly, a more reliable traffic flow-appropriate acceleration (and thus a more reliable target speed) can be calculated. As a result, needless acceleration and deceleration can be further suppressed, thus enabling even safer and smoother driving.

Next, an ACC system 3 according to a third example embodiment of the invention will be described with reference to FIG. 1.

The ACC system 3 differs from the ACC system 2 according to the second example embodiment in that it calculates the target speed also taking into account the vehicle states and attributes (i.e., the traveling tendencies), in addition to the speeds and positions of the reference vehicles around the host vehicle during traffic flow cruise control. Therefore, the only structure of the ACC system 3 that differs from the structures of the ACC system 1 of the first example embodiment and the ACC system 2 of the second example embodiment is a vehicle control ECU 53. Incidentally, in the third example embodiment, the radio antenna 11 and the radio control ECU 21 function as the obtaining portion of the invention, and the vehicle control ECU 53 functions as the target traveling speed calculating portion of the invention.

Incidentally, with vehicle-to-vehicle communication according to the radio antenna 11 and the radio control ECU 21, the transmitted and received information includes, in addition to the information described above, information about the existence of a safety system such as an Anti-lock Brake System (ABS), a Vehicle Stability Control (VSC), or a Pre-Crash Safety (PCS), and the activation state of this system, i.e., whether the system is activated or deactivated, information about the attribute of the vehicle when the vehicle is an emergency vehicle such as an ambulance, and if a vehicle is involved in an accident (hereinafter, simply referred to as an “accident vehicle”), information indicating such. Also, with roadside-to-vehicle communication according to the radio antenna 11 and the radio control ECU 21, the information that is received from the infrastructure equipment includes, in addition to the information described above, information about the position and vehicle ID of an accident vehicle if there is an accident vehicle.

The vehicle control ECU 53 differs from the vehicle control ECU 51 of the first example embodiment and the vehicle control ECU 52 of the second example embodiment only in terms of the traffic flow cruise control routine. Therefore, only the traffic flow cruise control of the vehicle control ECU 53 will be described.

The vehicle control ECU 53 selects reference vehicles to obtain a traffic flow-appropriate acceleration, from among other vehicles capable of vehicle-to-vehicle communication, by the same process as that employed by the vehicle control ECU 51 of the first example embodiment.

Then the vehicle control ECU 53 sets the weight mᵢ of each reference vehicle based on the speed, the position, the traveling state, and the attribute of each selected reference vehicle. Regarding the speeds and positions, the weights of the reference vehicles are set according to the same method as the methods described in the first and second example embodiments. Furthermore, regarding the traveling state, if a reference vehicle ahead is an accident vehicle (i.e., is stopped), the maximum weight (=1) is set (therefore the weights of all of the other reference vehicles are set to 0). Also, if a reference vehicle ahead is provided with a safety system and the safety system is activated, the weight is set large (for example, the weight set according to the speed and the position is multiplied by a coefficient larger than 1). Also, if a reference vehicle is exhibiting unusual behavior, the weight is set to 0. Regarding the attribute, if the vehicle is an emergency vehicle such as an ambulance, the weight is set to 0.

If there is an accident vehicle ahead, the host vehicle that is a trailing vehicle must quickly stop, so this kind of reference vehicle contributes the most to the calculation of the traffic flow-appropriate acceleration.

If there is a reference vehicle ahead in which a safety system is activated, this reference vehicle performs vehicle control to stabilize the vehicle behavior and avoid a collision. This kind of reference vehicle predicts an unstable state and performs vehicle control to drive more safely. Therefore, this kind of reference vehicle contributes more to the calculation of the traffic flow-appropriate acceleration in order to increase the safety of the host vehicle.

Examples of a vehicle that exhibits unusual behavior includes a vehicle that is traveling at an extremely short inter-vehicle distance, a vehicle that is flashing its headlights, and a vehicle that is overtaking unsafely. Because this kind of reference vehicle is likely to accelerate or decelerate suddenly and thus is a factor that reduces the safety of the host vehicle, the speed of this kind of reference vehicle does not contribute to the calculation of the traffic flow-appropriate acceleration. In determining whether a vehicle is exhibiting unusual behavior, the obtained speed and position and the like of another vehicle are stored in chronological order and the determination is made based on this traveling history, or if there is detecting means such as a camera, the state of the vehicle is monitored using the detecting means, and the determination is made based on the vehicle state.

An emergency vehicle exhibits unusual behavior by, for example, traveling at a different speed than nearby vehicles, e.g., going through a red light. Therefore, the speed of an emergency vehicle does not contribute to the calculation of the traffic flow-appropriate acceleration.

When the weights mᵢ of all of the reference vehicles are set, the vehicle control ECU 53 sequentially calculates the reference speed V_{ref}, the traffic flow-appropriate acceleration aₑₙᵥ, and the next target speed V_{tgt}_{_{—}}ₙₑₓₜ according to a similar process as the process performed by the vehicle control ECU 51 in the first example embodiment, and performs acceleration/deceleration control based on this next target speed V_{tgt}_{_{—}}ₙₑₓₜ.

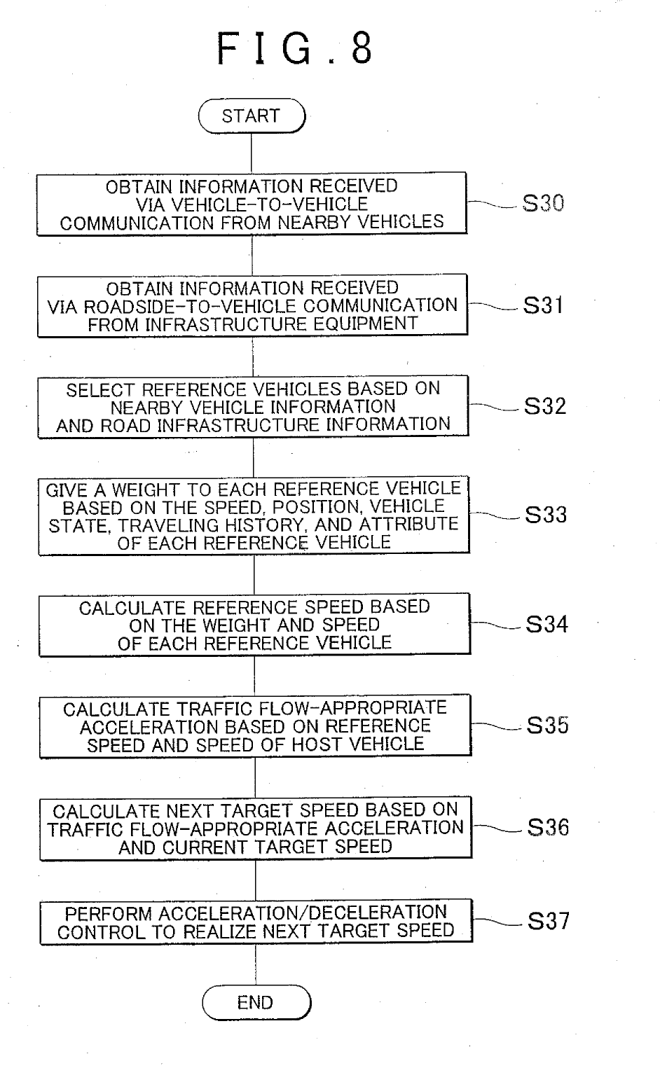

Now the operation during traffic flow cruise control of the ACC system 3 will be described with reference to FIG. 1. In particular, a traffic flow cruise control routine of the vehicle control ECU 53 will be described with reference to the flowchart shown in FIG. 8. FIG. 8 is a flowchart illustrating a traffic flow cruise control routine in the vehicle control ECU 53 according to the third example embodiment of the invention. Here, the operation of the ACC system 3 differs from the operation of the ACC system 1 described in the first example embodiment only in terms of the routine of the vehicle control ECU 53, so only the routine of the vehicle control ECU 53 will be described.

Steps S30 to S32 performed by the vehicle control ECU 53 are the same as steps S10 to S12 performed by the vehicle control ECU 51 in the first example embodiment. In particular, when obtaining information about the other vehicles around the host vehicle in step S30, the vehicle control ECU 53 stores the obtained information (i.e., the speed and position and the like) for each other vehicle in chronological order. Then when selecting the reference vehicles in step S32, the vehicle control ECU 52 gives a weight to each reference vehicle based on the speed, the position, the vehicle state (also including the traveling history), and the attribute of each selected reference vehicle (S33). The vehicle control ECU 53 then performs steps S34 to S37 that are the same as steps S14 to S17 performed by the vehicle control ECU 51 in the first example embodiment.

In addition to having the effects of the ACC system 1 in the first example embodiment, this ACC system 3 also has the effects described below. Examples of the traveling tendency determined from the traveling state and the attribute include the degree of driving safety and the degree of sudden acceleration or deceleration. When driving in accordance with a vehicle in which the degree of driving safety is high, driving may be safer. On the other hand, when driving in accordance with a vehicle in which the degree of sudden acceleration or deceleration is high, driving may involve a lot of sudden acceleration and sudden deceleration. With the ACC system 3, it is possible to set a more appropriate weight according to the reference vehicles that affect the traveling of the host vehicle, by taking into account the traveling states and the attributes, as well as the speeds and positions, when setting the weights of the reference vehicles. Accordingly, a more reliable traffic flow-appropriate acceleration (and thus a more reliable target speed) can be calculated. As a result, safety can be further increased and needless acceleration and deceleration can be further suppressed.

Hereinafter, various example embodiments of the invention have been described, but the invention is not limited to the foregoing example embodiments. That is, the invention may also be carried out in other modes.

For example, in the example embodiments, the invention is applied to an ACC system that performs lead vehicle following control and cruise control. Alternatively, however, the invention may also be applied to another apparatus, such as an apparatus that performs only cruise control (traffic flow cruise control in particular), or a apparatus that only sets a target speed of the vehicle according to the traffic flow.

Also, in the example embodiments, a target speed for cruise control is obtained, but the invention may also be applied for obtaining a target speed when driving according to an operation by the driver. In this case, information indicative of the obtained target speed may be provided to the driver as a recommended speed.

Further, in the example embodiments, the speeds and the like of the other vehicles are obtained via radio communication by the obtaining portion, but the speeds and the like of the other vehicles may also be obtained by other means.

Also, in the example embodiments, the calculated target speed is used in driving assist of the host vehicle, but the calculated target speed may also be transmitted to other vehicles around the host vehicle via vehicle-to-vehicle communication or roadside-to-vehicle communication. In this case, the radio antenna 11 and the radio control ECU 21 function as the transmitting portion of the invention.

Also, in the example embodiments, the driving assist apparatus of the invention is mounted in a vehicle. Alternatively, however, the infrastructure such as a center may be provided with a driving assist apparatus. In this case, the calculated target speed may be transmitted to the vehicle via roadside-to-vehicle communication or the like.

In the above cases, the vehicle to which the target speed is to be transmitted is may be selected and the target speed may be transmitted to the selected vehicle. The vehicle to which the target speed is transmitted may be, for example, a vehicle traveling near a slow vehicle (such as a vehicle that is within a predetermined distance of a vehicle traveling at or less than a predetermined speed), that is selected according to the position of the vehicle. Also, the vehicle to which the target speed is transmitted may be, for example, a vehicle positioned behind, in the direction of travel of, a slow vehicle (such as a vehicle traveling at a speed lower than a predetermined speed or the operating speed of a group of vehicles), that is selected according to the direction of travel of the vehicle.

Also, in the example embodiments, weights are set in order with the largest weight being given to the reference vehicle traveling at the lowest speed, among the plurality of selected reference vehicles. However, weighting may be performed as appropriate as long as a large weight is set for a reference vehicle traveling at a low speed. For example, the weight of a reference vehicle traveling at the lowest speed may be set to 1 and the weights of other reference vehicles may be set to 0 (i.e., only the speed of the reference vehicle traveling at the lowest speed is taken into account). Alternatively, the weights of several slow vehicles (such as two or three vehicles) may be set in order from the lowest speed and the weights of other reference vehicles may be set to 0 (i.e., only the speeds of the several slower reference vehicles is taken into account).

Further, in the example embodiments, weights are set for the selected reference vehicles, a reference speed is calculated based on the weight and speed of each reference vehicle, a traffic flow-appropriate acceleration is calculated based on this reference speed and the speed of the host vehicle, and the next target speed is calculated based on this traffic flow-appropriate acceleration and the current target speed. However, according to another method, the target speed of the host vehicle may also be calculated using set weights and the speeds of the reference vehicles. For example, the target speed of the host vehicle may be directly calculated from the weight and speed of each reference vehicle instead of obtaining the traffic flow-appropriate acceleration.

Also, in the third example embodiment, the target speed is obtained taking into account the vehicle states and attributes, in addition to the speeds and positions, of the reference vehicles during traffic flow cruise control. Alternatively, however, the target speed may be obtained taking into account the vehicle states and attributes, in addition to only the speeds of the reference vehicles, or the target speed may be obtained taking into account only one of the vehicle states or attributes, in addition to the speeds and positions of the reference vehicles.

Also, in the third example embodiment, the vehicle states and attributes are examples of the traveling tendencies of the reference vehicles. Alternatively, however, the traveling tendencies may also be something else other than the vehicle states or attributes that affect the operating speed. The vehicle states and attributes are also not limited to the examples given.

1. A driving assist apparatus for a vehicle, comprising:
an obtaining portion that obtains a speed of each of a plurality of vehicles; and
a target speed calculating portion that calculates a target speed based on a plurality of speeds obtained by the obtaining portion and respective degrees of influence of the plurality of speeds on the target speed,
wherein the target speed calculation portion sets the degree of influence of a lower speed to be larger than the degree of influence of a higher speed.

2. The driving assist apparatus according to claim 1, further comprising:
a transmitting portion that transmits the target speed to a vehicle.

3. The driving assist apparatus according to claim 1, wherein
the obtaining portion obtains information relating position of each of the plurality of vehicles in association with the speed; and
the target speed calculating portion changes the degree of influence according to the position.

4. The driving assist apparatus according to claim 1, further comprising:
a transmitting portion that selects a vehicle to which the target speed is to be transmitted and transmits the target speed to the selected vehicle.

5. The driving assist apparatus according to claim 4, wherein
the obtaining portion obtains information relating position of each of the plurality of vehicles in association with the speed; and
the transmitting portion selects the vehicle to which the target speed is to be transmitted, according to the position.

6. The driving assist apparatus according to claim 4, wherein
the obtaining portion obtains information relating to a travel direction of each of the plurality of vehicles in association with the speed; and
the transmitting portion selects the vehicle to which the target speed is to be transmitted, according to the travel direction.

7. The driving assist apparatus according to claim 1, wherein
the degree of influence is a weight that is set for each speed when the target speed calculating portion calculates the target speed.

8. The driving assist apparatus according to claim 1, wherein
the obtaining portion obtains information relating to a traveling tendency of each of the plurality of vehicles in association with the speed; and
the target speed calculating portion changes the degree of influence according to the traveling tendency.

9. A driving assist method for a vehicle, comprising:
obtaining a speed of each of a plurality of vehicles; and
calculating a target speed based on a plurality of speeds and respective degrees of influence of the plurality of speeds on the target speed, wherein the degree of influence of a lower speed is set to be larger than a degree of influence of a higher speed.

10. A vehicle in which driving assist is performed based on a target speed calculated by the driving assist apparatus according to the claim 1.

11. The vehicle according to claim 10, wherein a speed of the vehicle is controlled based on the target speed.
